(19) United States
(12) Patent Application Publication
(10) Pub. No.: US 2024/0319718 A1
(43) Pub. Date: Sep. 26, 2024

(54) SYSTEM AND METHOD FOR INTELLIGENT SCHEDULING OF MANUFACTURING JOBS

(71) Applicant: Quantiphi, Inc., Marlborough, MA (US)

(72) Inventors: Dagnachew Birru, Marlborough, MA (US); Anirudh Deodhar, Mumbai (IN); Achint Chaudhary, Mumbai (IN); Soumya Rani Samineni, Mumbai (IN)

(21) Appl. No.: 18/732,269

(22) Filed: Jun. 3, 2024

(51) Int. Cl. G05B 19/418

(52) U.S. Cl. CPC G05B 19/41865; G05B 19/41875; G05B 19/41885

(57) ABSTRACT

The present invention discloses a system for scheduling jobs within a manufacturing environment, integrating a plurality of sensors to capture operational parameters. A processing unit, linked to the plurality of sensors, analyzes datasets to determine the operational parameters. A machine learning module coupled to the processing unit, enhances a scheduling algorithm using the operational parameters. This machine learning module includes a first predictor for estimating job processing times and forecasting operating conditions based on these parameters. A formulator adjusts the scheduling algorithm using the forecasted operating conditions for distinct time intervals. Additionally, a second predictor forecasts subsequent operating conditions based on the modified scheduling algorithm and initial forecasts. The system optimizes job scheduling, enhancing efficiency and productivity within the manufacturing environment.

### TECHNICAL FIELD OF THE INVENTION

The present disclosure is related to system and method for scheduling jobs in a manufacturing environment.

### BACKGROUND OF THE INVENTION

Job scheduling in manufacturing environments has traditionally relied on manual or semi-automated processes, often characterized by limited flexibility and scalability. In these systems, scheduling tasks are typically performed by human operators or basic software programs that assign tasks to available resources based on predefined rules or priorities.

Early job scheduling systems primarily focused on optimizing resource utilization and minimizing idle time by assigning tasks to machines or workstations based on their availability and capacity. However, these systems lacked the ability to adapt to dynamic production environments and changing demand patterns, resulting in suboptimal scheduling decisions and inefficiencies.

As manufacturing processes became more complex and diversified, the need for more advanced job scheduling systems arose. These systems incorporated algorithms and optimization techniques to improve scheduling accuracy and responsiveness to changing production requirements. However, many of these early systems still relied on static scheduling models and lacked real-time data integration capabilities, limiting their ability to adapt to unforeseen disruptions or variations in production conditions.

The introduction of computerized job scheduling systems brought significant improvements in efficiency and flexibility to manufacturing operations. These systems utilized algorithms such as priority-based scheduling, shortest job first, and earliest due date to allocate resources and prioritize tasks based on predefined criteria. While these systems offered greater automation and optimization potential, they often struggled to handle the complexity and variability inherent in modern manufacturing environments.

Advanced manufacturing scheduling systems began to incorporate machine learning and artificial intelligence techniques to enhance scheduling accuracy and adaptability. These systems leveraged historical data, predictive models, and optimization algorithms to generate more intelligent and responsive scheduling decisions. However, challenges such as data integration, model complexity, and real-time execution remained significant barriers to achieving optimal scheduling performance.

Despite advancements in job scheduling technology, many manufacturing environments still face challenges related to inefficient resource utilization, production bottlenecks, and scheduling conflicts. The complexity of modern manufacturing processes, coupled with the variability and unpredictability of demand and production conditions, continues to present significant challenges for traditional job scheduling systems.

The limitations of the job scheduling systems include suboptimal resource utilization, lack of adaptability to changing production conditions, and difficulty in handling complex manufacturing processes. These systems often struggle to balance competing priorities, leading to inefficiencies, production delays, and increased operational costs. Additionally, the reliance on static scheduling models and manual intervention impedes the ability of these systems to respond quickly to disruptions or fluctuations in demand, resulting in decreased overall productivity and competitiveness in the manufacturing sector.

It is within this context that the present embodiments arise.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide method for scheduling jobs in a manufacturing environment, the method comprising obtaining one or more datasets indicating a plurality of operational parameters. The method may include receiving the one or more datasets; processing the one or more datasets to determine the plurality of operational parameters. The method may further include executing a machine learning module to update a scheduling algorithm with the plurality of operational parameters. The method may further include estimating processing time of the jobs scheduled within the manufacturing environment. The method may further include forecasting, via a first predictor, a first set of operating conditions of the manufacturing environment based on the plurality of operational parameters and the processing time. The method may further include modifying the scheduling algorithm using the first set of operating conditions forecasted by the first predictor. The scheduling algorithm is modified for a first time-interval and a second time interval. The method may also include forecasting, via a second predictor, a second set of operating conditions of the manufacturing environment for the first time-interval and the second time interval. The second set of operating conditions are forecast based on the first set of operating conditions and modified scheduling algorithm

According to some example embodiments, the operational parameters are selected from a group consisting of health and performance of equipment, quality of input material, environmental factors, and quality of output product.

According to some example embodiments, the method may further include merging the one or more datasets with data of a historical database.

According to some example embodiments, the method updating a machine learning module based on a deviation generated by processing the plurality of operational parameters from the one or more datasets, the first set of operating conditions and the second set of operating conditions.

According to some example embodiments, the first time-interval is indicative of a short-term period assigned for executing the scheduling algorithm, and a second time-interval is indicative of a long-term period for executing the scheduling algorithm.

According to some example embodiments, the method may further include generating an optimized scheduling workflow for each of the first time-interval and the second time interval based on the second set of operating conditions and the modified scheduling algorithm. The optimized scheduling workflow is generated by setting constraints and objectives for optimization problems.

According to some example embodiments, the method may further include simulating the manufacturing environment based on an optimized scheduling workflow.

According to some example embodiments, the method may further include recommending an optimized scheduling workflow for each of the first time-interval and the second time-interval.

According to some example embodiments, the first set of operating conditions and the second set of operating conditions indicate anticipated operational states, processing times and environmental factors of the manufacturing environment; and are derived from the operational parameters associated with the one or more datasets in real time.

Some example embodiments disclosed herein provide a system for scheduling jobs in a manufacturing environment. The system comprising a plurality of sensors configured to obtain one or more datasets indicating a plurality of operational parameters. The system may further include a processing unit communicably coupled with the plurality of sensors to receive the one or more datasets, and process the one or more datasets to determine the plurality of operational parameters. The system may further include a machine learning module executed by the processing unit to update a scheduling algorithm with the plurality of operational parameters. The machine learning module comprising a first predictor to estimate processing time of the jobs scheduled within the manufacturing environment, and forecast a first set of operating conditions of the manufacturing environment based on the plurality of operational parameters and the processing time. The machine learning module may further include a formulator to modify the scheduling algorithm using the first set of operating conditions forecasted by the first predictor. The scheduling algorithm is modified for a first time-interval and a second time interval. The machine learning module may further include a second predictor to forecast a second set of operating conditions of the manufacturing environment for the first time-interval and the second time interval. The second set of operating conditions are forecast based on the first set of operating conditions and modified scheduling algorithm.

According to some example embodiments, the first predictor functions on a pre-trained physics-informed neural network models and the second predictor functions on a long short-term memory model.

Some example embodiments disclosed herein provide a non-transitory computer readable medium having stored thereon computer executable instruction which when executed by a processing unit causing the processing unit to perform steps include obtaining one or more datasets indicating a plurality of operational parameters. The steps further may include receiving the one or more datasets. The steps further may include processing the one or more datasets to determine the plurality of operational parameters. The steps further may include executing a machine learning module to update a scheduling algorithm with the plurality of operational parameters. The steps further may include estimating processing time of the jobs scheduled within the manufacturing environment. The steps further may include forecasting, via a first predictor, a first set of operating conditions of the manufacturing environment based on the plurality of operational parameters and the processing time. The steps further may include modifying the scheduling algorithm using the first set of operating conditions forecasted by the first predictor. The scheduling algorithm is modified for a first time-interval and a second time interval. The steps further may include forecasting, via a second predictor, a second set of operating conditions of the manufacturing environment for the first time-interval and the second time interval, wherein the second set of operating conditions are forecast based on the first set of operating conditions and modified scheduling algorithm.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present disclosure will become apparent upon consideration of the following detailed description of embodiments thereof, especially when taken in conjunction with the accompanying drawings, and wherein:

FIG. 1 illustrates a schematic representation of a manufacturing environment having a job scheduling system, in accordance with an example embodiment;

FIG. 2 illustrates a block diagram of the job scheduling system, in accordance with an example embodiment;

FIG. 3 illustrates a schematic representation of the plurality of sensors installed within the manufacturing environment via the sensor hub, in accordance with an example embodiment;

FIG. 4 illustrates a block diagram of a machine learning module according to an exemplary embodiment;

FIG. 5 illustrates a schematic representation of the first predictor, according to an exemplary embodiment;

FIG. 6 illustrates a schematic representation of the second predictor, in accordance with an example embodiment;

FIG. 7 illustrates a schematic representation the formulator, in accordance with an example embodiment;

FIG. 8 illustrates a flowchart for a method for scheduling jobs in a manufacturing environment, in accordance with an example embodiment; and

FIG. 9 illustrates a block diagram of a computer system tailored for scheduling jobs in a manufacturing environment, in accordance with an example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The term “machine learning model” may be used to refer to a computational or statistical or mathematical model that is trained on classical ML modelling techniques with or without classical image processing. The “machine learning model” is trained over a set of data and using an algorithm that it may use to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

### End of Definitions

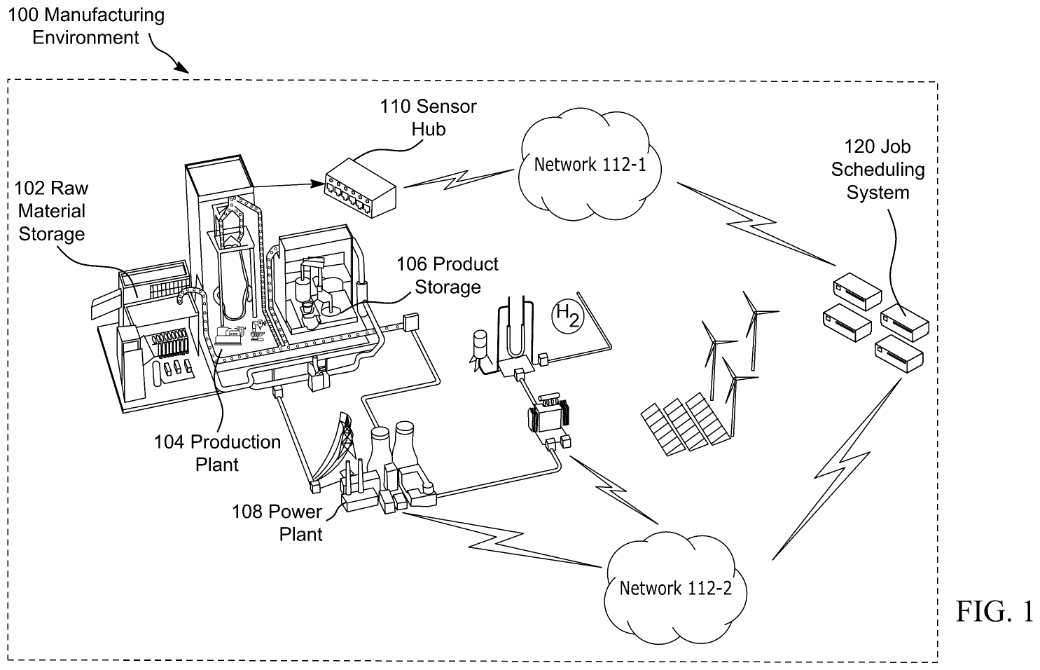

Embodiments of the present disclosure may provide a method, a system, and a computer program product for scheduling jobs in a manufacturing environment. The method, the system, and the computer program product for scheduling jobs in a manufacturing environment are described with reference to FIG. 1 to FIG. 9 as detailed below.

Integration of machine learning techniques within a scheduling system for manufacturing environments by leveraging a plurality of sensors to capture real-time operational parameters. The leverage enables the system to gain valuable insights into the current state of the manufacturing environment. This data is then processed by a machine learning module, which serves as the brain of the system, enabling it to adapt and make informed decisions in real-time.

One key aspect in the present subject matter is the use of predictive modelling to estimate processing times for jobs scheduled within the manufacturing environment and particularly, using future estimated processing times. By forecasting processing times based on operational parameters and historical data, the system can anticipate potential bottlenecks or delays in production, allowing for more accurate scheduling and resource allocation. This predictive capability enhances efficiency and productivity by reducing downtime and optimizing workflow.

Another critical component is the formulator, which dynamically adjusts the scheduling algorithm based on forecasted operating conditions. By continuously updating the algorithm with real-time data and predictions from the first predictor, the system can adapt to changing circumstances and optimize scheduling decisions for both short-term and long-term intervals. This adaptability ensures that the scheduling algorithm remains responsive to evolving conditions, leading to improved performance and resource utilization. In some cases, the formulator provides an input into a scheduler and uses estimations to properly frame an optimization problem.

Additionally, the inclusion of a second predictor further enhances the system's predictive capabilities by forecasting future operating conditions based on the modified scheduling algorithm. In some cases, future operating conditions are forecasted based on a modified input into the scheduler. This iterative approach enables the system to anticipate changes in the manufacturing environment and proactively adjust scheduling strategies accordingly. Overall, the integration of machine learning techniques into the scheduling system offers numerous advantages, including improved efficiency, enhanced adaptability, and optimized resource allocation, ultimately leading to increased productivity and competitiveness in manufacturing operations.

Referring to FIG. 1, illustrates a manufacturing environment 100, which includes a job scheduling system 120 described herein. The manufacturing environment 100 comprises various components, including a raw material storage 102, a production plant 104, a product storage 106, a power plant 108, a sensor hub 110, and network 112-1, 112-2. At the heart of this environment is the job scheduling system 120, tasked with orchestrating the efficient allocation of resources and tasks to meet production demands.

Scheduling of jobs in a manufacturing plant requires precise estimation of real-time machine conditions and product conditions. This involves monitoring parameters (interchangeably referred to as “operational parameters”) such as machine uptime, operating temperatures and or machine conditions, material quality, and production rates. In some embodiments, the operational parameters are selected from a group consisting of health and performance of equipment, quality of input material, environmental factors, and quality of output product. The job scheduling system 120 interfaces with the sensor hub 110 to gather real-time data from various sensors deployed throughout the manufacturing environment 100. The sensors capture information about machine performance, material characteristics, and environmental factors, providing crucial input for scheduling decisions.

In addition to real-time monitoring, effective scheduling also necessitates forecasting future machine and product conditions. Anticipating maintenance needs, product quality variations, and processing times as a function of changing raw material quality are essential for optimizing production workflows. The job scheduling system 120 incorporates predictive models and algorithms to estimate these future conditions based on historical data, machine learning techniques, and domain knowledge.

Heuristic-based estimations, while useful in some contexts, are often inadequate for the dynamic and complex nature of manufacturing environments. The job scheduling system 120 overcomes this limitation by employing advanced optimization techniques to rapidly formulate scheduling problems. By considering business demands such as fluctuations in product and raw material prices, energy consumption constraints, and product priorities, the system can generate optimal schedules that maximize efficiency and minimize costs

The raw material storage 102 serves as a repository for various materials used in the production process. The job scheduling system 120 interfaces with the raw material storage 102 to access inventory levels, material specifications, and delivery schedules. By incorporating this information into its scheduling algorithms, the system can ensure timely availability of materials for production tasks.

Within the production plant 104, the job scheduling system 120 coordinates the execution of manufacturing processes across different machines and production lines. It assigns tasks to available resources based on factors such as machine capabilities, product requirements, and production deadlines. By dynamically adjusting schedules in response to changing conditions, the system optimizes throughput and minimizes idle time.

Once products are manufactured, they are transferred to the product storage 106 for temporary storage or distribution. The job scheduling system 120 manages the movement of finished goods within the facility, optimizing storage space utilization and ensuring timely delivery to customers or downstream processes. By considering factors such as product demand, shelf life, and storage capacity, the system maximizes inventory turnover and minimizes obsolescence.

The power plant 108 provides energy resources to support the operation of the manufacturing environment 100. The job scheduling system 120 interfaces with the power plant 108 to optimize energy usage and minimize costs. By scheduling tasks to coincide with periods of low energy demand or leveraging renewable energy sources when available, the system reduces energy expenses and environmental impact.

The sensor hub 110 acts as a centralized data collection and distribution point, aggregating sensor data from across the manufacturing environment 100. The job scheduling system 120 leverages this data to monitor machine performance, detect anomalies, and predict future conditions. By integrating real-time sensor data into a decision-making process, the system can dynamically adjust schedules to optimize performance and adapt to changing circumstances.

The network 112-1, 112-2 facilitates communication and data exchange between the various components of the manufacturing environment 100 and the job scheduling system 120. Through seamless connectivity, the system can access real-time information, collaborate with other systems, and coordinate activities across different parts of the facility. This enables efficient resource allocation, timely decision-making, and streamlined operations.

The network 112-1, 112-2 operates via diverse modes of communication, including but not limited to wired and wireless technologies, to accommodate the specific requirements and configurations of the manufacturing environment. Wired connections such as Ethernet facilitate robust and high-speed data transfer, ensuring reliability and stability in communication between interconnected devices and systems. Wireless technologies such as Wi-Fi, Bluetooth, and cellular networks offer flexibility and mobility, enabling remote monitoring and control of manufacturing operations across different locations within the facility.

Furthermore, the network may incorporate other communication protocols and standards such as TCP/IP, UDP, MQTT, Modbus, and OPC UA, among others, to support interoperability and compatibility with various industrial equipment and systems. This multi-modal approach to networking enhances the versatility and adaptability of the communication infrastructure, enabling seamless integration of disparate components and facilitating real-time data exchange and collaboration across the manufacturing environment.

In conclusion, the job scheduling system 120 plays a vital role in optimizing production processes within the manufacturing environment 100. By leveraging real-time sensor data, predictive analytics, and advanced optimization techniques, the system can generate schedules that maximize efficiency, minimize costs, and adapt to changing conditions. With its ability to accurately estimate machine and product conditions, rapidly formulate scheduling problems, and consider business demands, the system offers a powerful tool for enhancing productivity and competitiveness in manufacturing operations.

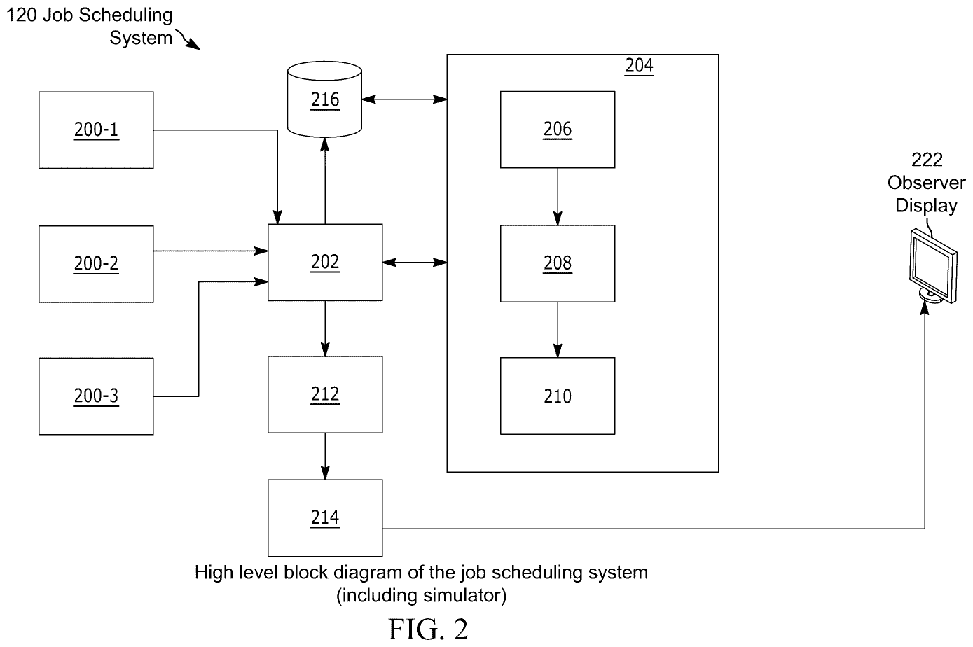

Referring to FIG. 2 illustrates a block diagram of the job scheduling system 120, in accordance with an example embodiment. FIG. 2 depicts a comprehensive view of the job scheduling system 120, comprising a plurality of sensors 200-1, 200-2, 200-3, a processing unit 202, and a machine learning module 204 that includes a first predictor 206, a formulator 208, and a second predictor 210. The job scheduling system 120 further a recommender 212, a simulator 214, a historical database 216, a feedback module 218, and an observer display 222. This system represents an integrated approach to optimizing job scheduling in a manufacturing environment by leveraging advanced data processing, predictive analytics, and decision support capabilities.

The plurality of sensors 200-1, 200-2, 200-3 are strategically deployed throughout the manufacturing environment 100 to capture real-time data on machine performance, material quality, environmental conditions, and other relevant parameters. These sensors interface with the processing unit 202, which serves as the central hub for data aggregation, pre-processing, and analysis. In FIG. 2, a plurality of sensors, specifically sensors 200-1, 200-2, and 200-3, are depicted for illustrative purposes. It is important to note that while three sensors are shown in the figure, the actual number of sensors utilized within the manufacturing environment may vary. The representation of three sensors in FIG. 2 serves as a simplified illustration to convey the concept of sensor deployment and functionality within the system.

It should be understood that the use of more than three sensors or fewer than three sensors is feasible and within the scope of the invention described herein. The specific number of sensors deployed may depend on various factors such as the size of the manufacturing facility, the complexity of production processes, and the desired level of monitoring and control. Therefore, the depiction of three sensors in FIG. 2 is not intended to limit the scope of the invention to only three sensors but rather to provide a clear and concise representation of sensor functionality within the context of the overall system architecture.

The processing unit 202 collects and consolidates sensor data, performs data cleaning and transformation, and prepares it for further analysis by the machine learning module 204. The processing unit 202 is communicably coupled with the plurality of sensors to receive the one or more datasets, and process the one or more datasets to determine the plurality of operational parameters.

The machine learning module 204 encompasses various algorithms and models designed to extract meaningful insights from the collected data. It employs techniques such as supervised learning, unsupervised learning, and reinforcement learning to identify patterns, trends, and anomalies in the data. The machine learning module 204 continuously adapts and evolves based on new data inputs, enabling it to provide increasingly accurate predictions and recommendations over time. The machine learning module 204 is executed by the processing unit 202 to update a scheduling algorithm with the plurality of operational parameters.

The first predictor 206 is a key component of the machine learning module 204, specializing in forecasting future conditions and events based on historical data and current observations. It utilizes advanced predictive models and algorithms to estimate parameters such as machine downtimes, material shortages, and production bottlenecks. The predictions generated by the first predictor 206 serve as valuable input for subsequent decision-making processes within the scheduling system. The first predictor estimates processing time of the jobs scheduled within the manufacturing environment, and forecasts a first set of operating conditions of the manufacturing environment based on the plurality of operational parameters and the processing time. In an example, if a steel manufacturing plant schedules a batch of steel rods for production, the first predictor estimates the time required for heating and cooling processes based on factors like furnace temperature, material composition, and production volume. Additionally, using this estimated processing time, the first predictor forecasts the corresponding operating conditions for the manufacturing environment, such as optimal furnace temperature ranges and cooling rates, ensuring efficient and effective job scheduling to meet production targets.

The formulator 208 is responsible for translating the predictions from the first predictor 206 into actionable scheduling decisions. It dynamically adjusts scheduling parameters, constraints, and objectives based on the forecasted conditions, optimizing resource allocation and task sequencing to maximize production efficiency and minimize disruptions. The formulator 208 operates in real-time, continuously updating scheduling plans to reflect changing circumstances and priorities. The formulator 208 modifies the scheduling algorithm using the first set of operating conditions forecasted by the first predictor and the scheduling algorithm is modified for a first time-interval and a second time interval. In some embodiments, the first time-interval is indicative of a short-term period for assigned for executing the scheduling algorithm, and the second time-interval is indicative of a long-term period for executing the scheduling algorithm. In some embodiments, the formulator 208 is configured to generate an optimized scheduling workflow for each of the first time-interval and the second time interval based on the second set of operating conditions and the modified scheduling algorithm, and the optimized scheduling workflow is generated by setting constraints and objectives for optimization problems.

For example, the short-term interval indicates immediate production needs, for which the formulator 208 prioritizes tasks based on predicted machine conditions and current operational parameters. This ensures that resources are allocated efficiently to meet real-time production demands while minimizing energy consumption and maximizing throughput.

The long-term interval covers future production cycles, the formulator 208 considers factors such as anticipated changes in raw material availability and maintenance schedules. By incorporating forecasted operating conditions into the scheduling algorithm, the formulator 208 optimizes production plans to adapt to evolving circumstances and ensure sustained efficiency and profitability for the manufacturing plant. This approach allows the system to proactively address both immediate and future production challenges, leading to optimized resource utilization and enhanced overall performance.

The second predictor 210 builds upon the predictions generated by the first predictor 206, further refining and extending them to encompass longer time horizons and more complex scenarios. It utilizes sophisticated forecasting techniques and domain-specific knowledge to anticipate future trends and developments, enabling proactive planning and risk mitigation strategies. The second predictor 210 provides valuable insights into potential long-term challenges and opportunities, empowering decision-makers to make informed strategic choices. The second predictor forecasts a second set of operating conditions of the manufacturing environment for the first time-interval and the second time interval.

The second set of operating conditions are forecast based on the first set of operating conditions and modified scheduling algorithm. The second set of operating conditions refers to the forecasted parameters that indicate the expected state of the manufacturing environment over specified time intervals. These conditions include various factors such as machine conditions, product quality, environmental factors, and other relevant parameters that influence production processes. In some embodiments, the first set of operating conditions and the second set of operating condition indicate anticipated operational states, processing times and environmental factors of the manufacturing environment and are derived from the operational parameters associated with the one or more datasets in real time. In some embodiments, the second set of operating conditions may also refer to remaining useful cycle life, raw material availability in future, environmental factors in future.

The second predictor utilizes information from the first predictor's forecasts and the modified scheduling algorithm to predict how these operating conditions will evolve over both short-term and long-term intervals. By considering the adjustments made to the scheduling algorithm based on the forecasted first set of operating conditions, the second predictor provides updated forecasts for subsequent time intervals, allowing for more accurate planning and decision-making in the manufacturing environment. In addition to the above, the second set of parameters go as input to first predictor model again to estimate processing times in future for diff combinations of machines, jobs, operations, raw materials, product grades etc.

The recommender 212 recommends an optimized scheduling workflow for each of the first time-interval and the second time-interval. 212 The recommender 212 leverages the predictions and recommendations generated by the first and second predictors 206, 210 to provide personalized guidance and advice to users. It analyzes historical performance data, current conditions, and future projections to offer tailored suggestions for optimizing scheduling decisions. The recommender 212 enhances decision-making processes by highlighting key insights, identifying best practices, and recommending courses of action to achieve desired outcomes.

The simulator 214 simulates the manufacturing environment 100 based on an optimized scheduling workflow. The simulator 214 serves as a virtual sandbox environment for testing and evaluating different scheduling scenarios and strategies. It allows users to simulate various production scenarios, modify scheduling parameters, and observe the potential impact on performance metrics such as throughput, efficiency, and cost. The simulator 214 provides a valuable tool for training, experimentation, and decision support, enabling users to explore alternative approaches and make informed decisions without disrupting actual production operations.

The historical database 216 serves as a repository for storing and organizing past performance data, sensor readings, scheduling plans, and other relevant information. It provides a valuable resource for retrospective analysis, trend identification, and performance benchmarking. The historical database 216 enables users to track and evaluate the effectiveness of past scheduling decisions, identify areas for improvement, and learn from past experiences. In some embodiments, the processing unit is further configured to merge the one or more datasets with data of a historical database.

In some embodiments, the historical database includes data from diverse sources such as Manufacturing Execution Systems (MES), Distributed Control Systems (DCS), and Laboratory Information Management Systems (LIMS) is paramount. These systems provide a wealth of operational data, including production metrics, process parameters, quality control data, and equipment statuses.

Upon ingestion, the data undergoes pre-processing steps, which may involve averaging, error removal, and normalization to ensure consistency and reliability. By standardizing the format and structure of the data, it becomes easier to merge with existing datasets stored in databases, facilitating seamless integration with historical records and enabling comprehensive analyses across different time periods.

Once pre-processed, the data is merged with standardized tables and lists within the database, where it becomes part of a unified repository of manufacturing information. This amalgamation of real-time and historical data sets the stage for advanced analytics, predictive modelling, and decision-making processes. By leveraging the combined insights from MES, DCS, LIMS, and historical data, manufacturing stakeholders gain a holistic view of operations, allowing them to identify patterns, trends, and anomalies more effectively.

Ultimately, this integrated approach to data management and analysis enhances the capabilities of intelligent real-time scheduling systems, enabling more informed and optimized decision-making in manufacturing environments.

The feedback module 218 facilitates the collection and integration of feedback from users, production operators, and other stakeholders. It solicits input on scheduling decisions, performance outcomes, and user experiences, allowing the system to learn from past successes and failures and refine its algorithms and recommendations accordingly. The feedback module 218 fosters a continuous improvement loop, driving ongoing optimization and innovation within the scheduling system. In some embodiments, the feedback module 218 updates machine learning module based on a deviation generated by processing the plurality of operational parameters from the one or more datasets, the first set of operating conditions and the second set of operating conditions. The term “deviation” refers to change in the expected or normative conditions within the manufacturing environment. This could include anomalies or deviations in machine conditions, faults, incomplete orders, or any other unexpected variations in operational parameters that could impact the scheduling process.

In an example, when the first predictor forecasts optimal operating conditions based on historical data and current operational parameters, including factors like temperature, pressure, and material quality. The second predictor then forecasts future operating conditions based on the modified scheduling algorithm and the forecasted first set of conditions.

During the production process, if one of the sensors detects a sudden increase in temperature in the furnace where the steel rods are being heated. This temperature spike could indicate a potential equipment malfunction or deviation from the expected operating conditions. This deviation triggers the feedback module, which alerts the machine learning module to reevaluate the scheduling algorithm in light of this unexpected event.

The machine learning module may then analyze the deviation, along with the first and second sets of operating conditions, to determine the appropriate course of action. It may decide to adjust the scheduling algorithm to prioritize maintenance on the affected equipment or allocate additional resources to compensate for the deviation and prevent production delays. In this scenario, the feedback module plays a crucial role in ensuring the adaptability and responsiveness of the scheduling system. By promptly identifying and addressing deviations from expected operating conditions, the system can effectively mitigate risks, minimize downtime, and optimize production efficiency in dynamic manufacturing environments.

The observer display 222 provides a user-friendly interface for operators and stakeholders to interact with the scheduling system and visualize key insights and performance metrics. It presents real-time dashboards, reports, and visualizations that convey critical information about production status, resource utilization, and scheduling efficiency. The observer display 222 enables users to monitor production operations, track key performance indicators, and make informed decisions based on the latest data and insights provided by the scheduling system.

In operation, the plurality of sensors 200-1, 200-2, 200-3 capture real-time data on machine performance, material quality, and environmental conditions within the manufacturing environment 100. The processing unit 202 aggregates, pre-processes, and analyzes the sensor data to extract meaningful insights and identify patterns and trends. The machine learning module 204 utilizes advanced algorithms and models to interpret the data, generate predictions, and provide recommendations for optimizing production scheduling. The first predictor 206 forecasts short-term operating conditions and events, while the second predictor 210 extends these predictions to longer time horizons and more complex scenarios. The formulator 208 dynamically adjusts scheduling parameters and objectives based on the predictions from the predictors, optimizing resource allocation and task sequencing in real-time. The recommender 212 provides personalized guidance and advice to users, helping them make informed decisions and achieve desired outcomes. The simulator 214 enables users to simulate different scheduling scenarios, evaluate their potential impact, and explore alternative strategies without disrupting actual production operations. The historical database 216 stores past performance data and scheduling plans, providing a valuable resource for retrospective analysis and performance benchmarking. In combination with the historical database 216, the recommender leverages historical data stored in the database to enhance decision-making and optimization strategies. The recommender analyzes past scheduling patterns, resource allocations, and outcomes to identify effective scheduling strategies and recommend optimal courses of action for future scheduling tasks.

By mining historical data, the recommender can uncover hidden patterns, correlations, and insights that may not be immediately apparent from real-time data alone. This historical context enables the recommender to provide valuable recommendations based on past successes and failures, helping to guide scheduling decisions towards the most favorable outcomes.

For example, a steel manufacturing plant encounters recurring production delays during certain time periods due to equipment breakdowns or material shortages. By analyzing historical data, the recommender may identify common causes of these delays and recommend proactive measures to mitigate their impact in future scheduling plans. This could include adjusting production schedules, optimizing maintenance routines, or stockpiling critical materials to ensure uninterrupted operations during peak demand periods.

Furthermore, the recommender can adapt its recommendations over time as new data becomes available and the manufacturing environment evolves. By continuously learning from past scheduling experiences and incorporating feedback from scheduling outcomes, the recommender can refine its recommendations and improve the overall effectiveness of the scheduling process. In essence, the recommender serves as a valuable decision support tool for schedulers and operators, providing actionable insights and recommendations based on historical data analysis. By harnessing the power of machine learning and historical knowledge, the recommender empowers organizations to make more informed, data-driven scheduling decisions that drive operational efficiency and enhance overall performance in the manufacturing environment.

The feedback module 218 collects input from users and stakeholders, facilitating a continuous improvement loop and driving ongoing optimization and innovation within the scheduling system. The observer display 222 presents real-time dashboards and visualizations, allowing users to monitor production operations, track key performance indicators, and make informed decisions.

In some embodiments, the system 120 may further refine predictive capabilities by incorporating the first predictor before the forecasts are generated by the second predictor. Following a similar workflow as before, the plurality of sensors collects operational data, which is then processed by the processing unit to determine the operational parameters. The first predictor estimates the processing time for scheduled jobs and forecasts the initial set of operating conditions based on this data.

However, before proceeding to the second predictor, the system revisits the first predictor to refine its predictions. Once the first predictor provides updated forecasts, the system then employs the second predictor to generate a more nuanced understanding of the operating conditions for specified time intervals. With this enhanced insight, the formulator modifies the scheduling algorithm to optimize job scheduling.

By integrating the feedback loop of the first predictor before the second predictor's forecasts, the system iteratively improves its predictive capabilities and fine-tunes the scheduling algorithm formulation based on the latest predictions. This iterative process ensures that the scheduling algorithm remains adaptive and responsive to dynamic changes within the manufacturing environment, ultimately leading to improved efficiency and productivity.

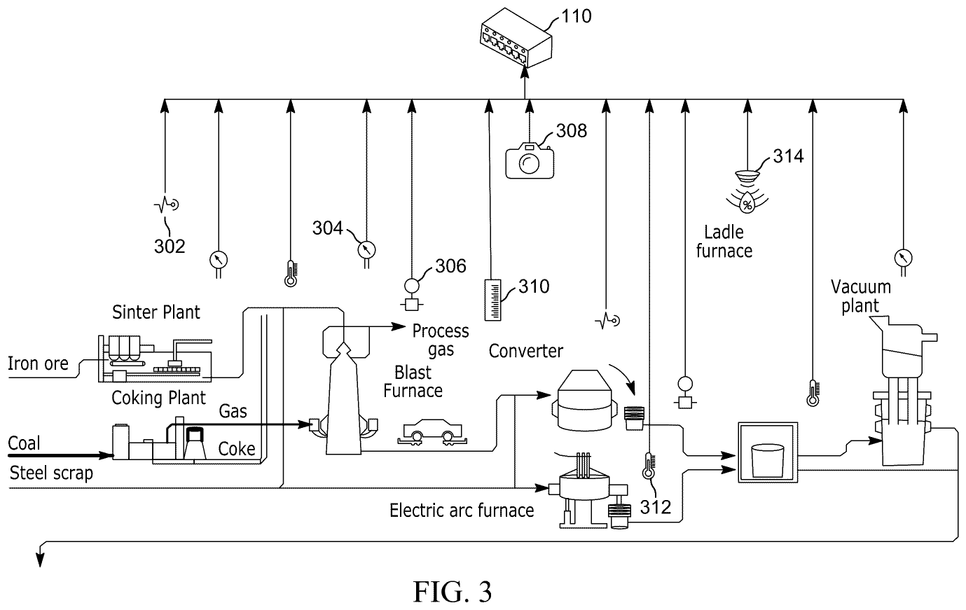

Referring to FIG. 3, illustrates a schematic representation of the plurality of sensors 200 installed within the manufacturing environment 100 via the sensor hub 110, in accordance with an example embodiment.

The arrangement and types of sensors are illustrated visually to demonstrate their distribution and functionality within the manufacturing environment 100. These sensors may include but are not limited to:

Temperature Sensors 312: These sensors are depicted by the symbol of a thermometer and are utilized to measure the temperature of equipment, materials, and ambient surroundings within the manufacturing facility. For example, temperature sensors are placed near furnaces, ovens, and cooling systems to monitor thermal conditions and ensure optimal operating temperatures.

Pressure Sensors 304: Represented by a pressure gauge icon, pressure sensors are employed to measure fluid pressures and air pressures in various processes and equipment. In a steel manufacturing plant, pressure sensors are installed in hydraulic systems, pneumatic machines, and pressurized vessels to monitor pressure levels and detect anomalies that could indicate leaks or malfunctions.

Flow Sensors 306: Displayed as a flow meter symbol, flow sensors are utilized to measure the flow rate of liquids or gases in pipelines and conduits. In a manufacturing environment, flow sensors are installed in pipelines carrying raw materials, cooling fluids, and process gases to ensure consistent flow rates and detect any deviations that may affect production efficiency.

Proximity Sensors 302: Shown as a proximity sensor icon, these sensors detect the presence or absence of objects within their proximity without physical contact. In a steel manufacturing plant, proximity sensors are used to monitor the position of moving components such as conveyor belts, robotic arms, and crane systems, ensuring safe and efficient operation.

Level Sensors 310: Represented by a level gauge symbol, level sensors are employed to measure the level of liquids, powders, or granular materials in tanks, silos, and containers. In the context of steel manufacturing, level sensors are installed in storage tanks for molten metal, raw materials, and chemical solutions to maintain optimal inventory levels and prevent overflows or shortages.

Humidity Sensors 314: Depicted by a humidity sensor icon, these sensors measure the moisture content or relative humidity of the air in the manufacturing environment. Humidity sensors are crucial in steel manufacturing to control atmospheric conditions in facilities such as blast furnaces, where precise humidity levels are essential for the efficiency of metallurgical processes.

Camera Sensors 308: Represented by a camera symbol, camera sensors are used to capture visual information and monitor operations in real-time. In a manufacturing environment, cameras are positioned strategically to provide visual surveillance of production processes, equipment status, and worker safety. For instance, cameras installed in rolling mills and casting areas help operators monitor product quality, detect defects, and ensure compliance with safety protocols.

In an example embodiment, temperature sensors 312 installed near blast furnaces monitor the temperature of molten metal and slag, ensuring precise control of the smelting process and preventing overheating or underheating. Pressure sensors 304 integrated into hydraulic systems regulate the pressure of hydraulic fluids used to operate heavy machinery such as presses and forging equipment, minimizing the risk of hydraulic failures, and ensuring consistent performance.

Flow sensors 306 installed in cooling water pipelines measure the flow rate of coolant circulated around hot metal surfaces, helping to maintain optimal cooling rates and prevent thermal stress and warping in finished products. Proximity sensors 302 mounted on conveyor belts detect the presence of metal ingots and slabs as they move through the production line, enabling automated sorting and routing of materials to different processing stages.

Level sensors 310 installed in storage tanks for raw materials such as iron ore and coal monitor inventory levels and trigger replenishment orders when supplies are running low, ensuring uninterrupted production and timely delivery of materials to downstream processes.

Humidity sensors 314 deployed in furnace halls and casting areas control the moisture content of the air, preventing excessive humidity that could lead to condensation and corrosion of equipment surfaces. Camera sensors 308 positioned along rolling mill lines capture high-resolution images of steel products during the rolling process, allowing operators to inspect surface defects, dimensional accuracy, and product finish in real-time, thus ensuring compliance with quality standards and customer specifications.

The sensors are connected to a sensor hub 110 through wired or wireless mode. The data obtained from the various sensors are collected at the sensor hub to be processed further.

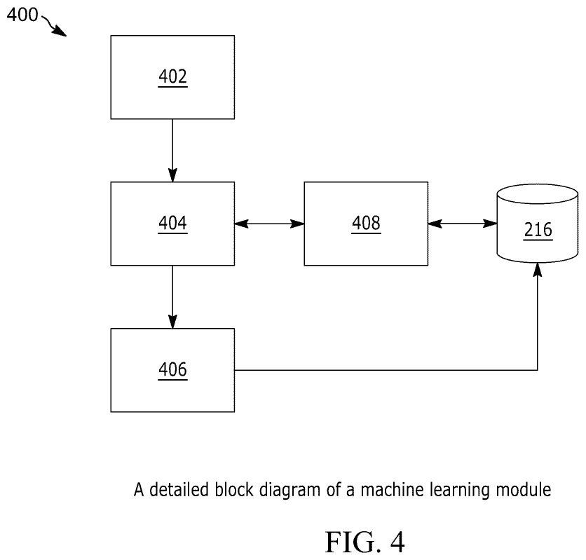

Referring to FIG. 4, illustrates a block diagram of a machine learning module 400 according to an exemplary embodiment. The machine learning module 400 is similar to the machine learning module 204 of FIG. 2. The machine learning module 400 includes a first predictor 402, a formulator 404, a second predictor 406, and a rule extractor 408.

The first predictor 402 is responsible for forecasting short-term operating conditions and events within the manufacturing environment. This predictor utilizes pre-trained physics-informed neural network models, which are specifically designed to capture the underlying physical principles governing the behavior of the manufacturing processes. By incorporating domain knowledge into the model architecture, the first predictor can effectively extrapolate from limited data and provide accurate predictions of machine conditions, product quality, and environmental factors in real-time. In contrast, the second predictor 406 extends the forecasting horizon to longer time intervals and more complex scenarios.

Unlike the first predictor, which focuses on short-term predictions, the second predictor employs a long short-term memory (LSTM) model to capture temporal dependencies and patterns in the data. This allows the second predictor to forecast future operating conditions and anticipate potential disruptions or deviations from expected norms over extended time periods.

The formulator 404 acts as an intermediary between the predictors and the scheduling algorithm, dynamically adjusting scheduling parameters and objectives based on the predictions generated by the predictors. By incorporating forecasted operating conditions into the scheduling process, the formulator ensures that scheduling decisions are aligned with current and future production requirements, resource availability, and business priorities.

Additionally, the rule extractor 408 plays a crucial role in uncovering implicit rules and patterns in the data, which can inform decision-making and optimization strategies within the scheduling system. By analyzing historical data and identifying recurring patterns or anomalies, the rule extractor enables the system to adapt and learn from past experiences, improving the accuracy and efficiency of scheduling decisions over time.

In an example, the functionality of the rule extractor involves analyzing historical production data from a semiconductor manufacturing plant. Suppose the rule extractor discovers a recurring pattern of equipment failures occurring after prolonged periods of high temperature and humidity levels in the production environment. By correlating these environmental conditions with equipment downtime, the rule extractor identifies a potential causal relationship and recommends proactive measures to mitigate the risk of future failures. Additionally, the rule extractor may uncover hidden dependencies between production variables, such as material flow rates, equipment utilization, and energy consumption. By identifying these dependencies, the rule extractor can suggest optimizations to the production process, such as adjusting production schedules to minimize peak energy demand or optimizing material handling procedures to reduce waste and improve efficiency.

In another example embodiment, the machine learning module involves predicting machine downtime and maintenance requirements in a steel manufacturing plant. The first predictor utilizes pre-trained physics-informed neural network models to forecast short-term variations in machine operating conditions, such as temperature, pressure, and vibration levels. Based on these predictions, the formulator adjusts the scheduling algorithm to prioritize maintenance tasks and allocate resources accordingly. Meanwhile, the second predictor employs an LSTM model to forecast longer-term trends and potential equipment failures, taking into account historical maintenance records, environmental factors, and production schedules. By integrating these forecasts into the scheduling process, the system can proactively schedule preventative maintenance activities, minimize unplanned downtime, and optimize overall equipment effectiveness in the manufacturing plant.

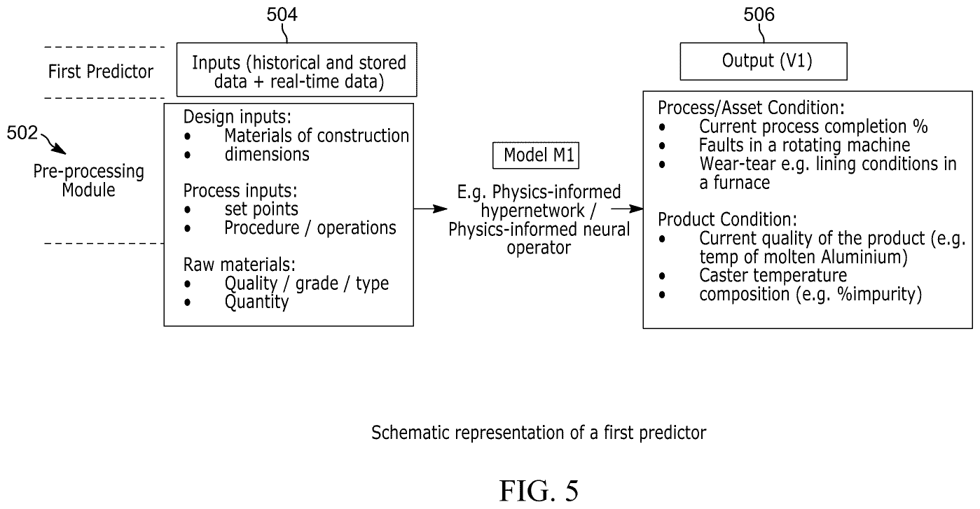

Referring to FIG. 5, illustrates a schematic representation of the first predictor 500 and its role in forecasting short-term operating conditions and events within the manufacturing environment. The first predictor functions as a critical component of the machine learning module, utilizing pre-trained physics-informed neural network models to interpret a wide array of inputs and generate predictions of process and product conditions in real-time.

The first predictor 500 comprises a pre-processing module 502 that performs tasks such as data cleaning, normalization, and feature extraction, ensuring that the input data is formatted in a manner conducive to accurate forecasting. The first predictor 500 further comprises an input block 504 that serves as the gateway for incorporating relevant data into the predictive modeling process. It accepts the processed data from the pre-processing module 502 and feeds it into the predictive models for analysis. This block is responsible for structuring the input data in a manner that enables effective modeling of processing times, quality expectations, machine faults, and other critical parameters. The first predictor 500 further comprises an output block 506 that is responsible for interpreting and presenting the forecasted results. It translates the model's predictions into actionable insights, providing estimates of processing times, quality metrics, and other relevant parameters essential for scheduling optimization. Additionally, the output block 506 may facilitate the integration of these forecasts into the scheduling algorithm, ensuring that the system's decision-making process is informed by real-time predictive insights.

The inputs to the first predictor encompass a combination of historical and real-time data, providing a comprehensive snapshot of the manufacturing environment. Historical data includes information on materials of construction, dimensions, set-points, procedures, operations, raw material quality, and quantities, while real-time data captures instantaneous measurements and observations from sensors distributed throughout the production facility.

Design inputs such as materials of construction and dimensions provide essential context for understanding the structural properties of equipment and facilities within the manufacturing environment. Process inputs, including set-points and procedural details, offer insights into the operational parameters and requirements governing various manufacturing processes.

Raw material specifications, including quality grades, types, and quantities, are crucial factors influencing the quality and composition of the final product. By incorporating these inputs into its predictive models, the first predictor can anticipate variations in raw material properties and their potential impact on production outcomes.

The outputs generated by the first predictor, denoted as V1, encompass predictions of both process/asset conditions and product conditions. Process/asset condition predictions may include estimates of current process completion percentages, assessments of machinery health based on model M1, and identification of potential faults or wear-and-tear in rotating machinery such as furnace linings.

Similarly, product condition predictions provide insights into the quality and characteristics of the final product, such as the temperature of molten aluminium, caster temperature, and composition, including impurity levels. These predictions enable operators and decision-makers to proactively address process deviations, optimize production parameters, and ensure the quality and consistency of manufactured products.

The pre-trained physics-informed neural network models utilized by the first predictor 500 represent a sophisticated approach to forecasting short-term operating conditions in the manufacturing environment. These models combine the power of neural network algorithms with the foundational principles of physics to capture the complex interplay of variables and dynamics inherent in industrial processes.

One key advantage of physics-informed neural network models lies in their ability to encode domain-specific knowledge and physical principles directly into the learning process. By incorporating fundamental laws of physics, such as conservation of mass, energy, and momentum, into the network architecture, these models can effectively capture the underlying physics governing manufacturing processes.

In the context of a manufacturing plant, the physics component of these models enables a deeper understanding of the underlying mechanisms driving process dynamics and product quality. For example, in a steel production facility, the physics-informed neural network models may account for factors such as heat transfer, fluid flow, and chemical reactions occurring within the blast furnace and casting processes.

In an example, the application of physics-informed neural network models involves forecasting the temperature distribution within a continuous casting operation. By leveraging historical data on process inputs, raw material properties, and equipment specifications, the neural network model can predict the temperature profile along the length of the casting mold with high accuracy.

The physics component of the model ensures that predictions adhere to fundamental principles governing heat transfer and fluid flow, accounting for factors such as thermal conductivity, convection, and solidification kinetics. This enables operators to anticipate temperature gradients, identify potential hot spots or cold zones, and adjust process parameters accordingly to optimize casting quality and throughput.

Overall, the integration of pre-trained physics-informed neural network models into the first predictor 500 enhances its predictive capabilities and enables more accurate forecasting of process and product conditions in the manufacturing environment. By harnessing the power of physics-based modelling alongside advanced machine learning techniques, organizations can gain deeper insights into their production processes and drive continuous improvement in operational performance and product quality.

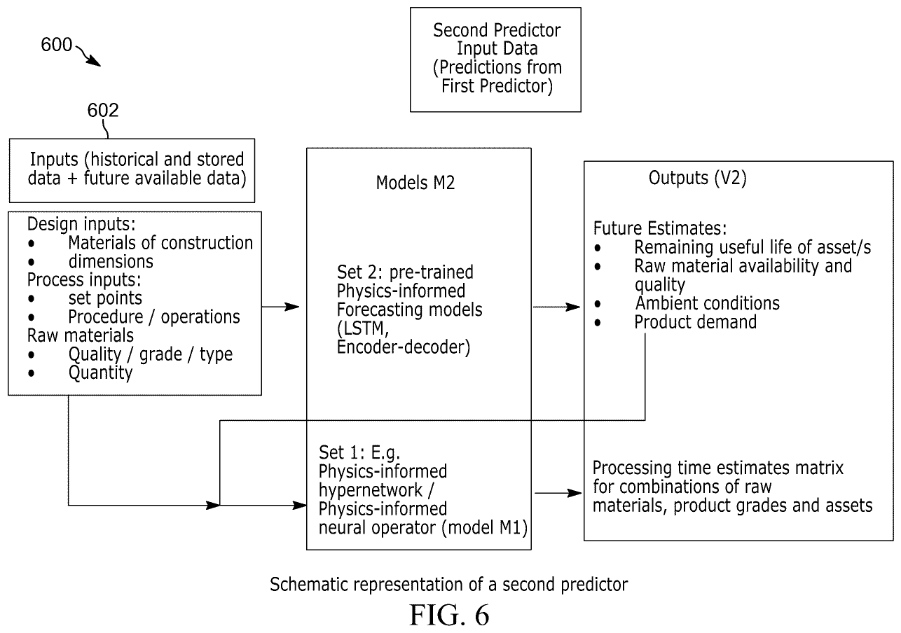

Referring to FIG. 6, illustrates a schematic representation of the second predictor 600 and its role in forecasting future operating conditions and events within the manufacturing environment. Unlike the first predictor, the second predictor 600 operates using a long short-term memory (LSTM) model, a type of recurrent neural network (RNN) known for its ability to capture long-range dependencies and temporal dynamics in sequential data. The second predictor 600 includes an input module 602 that acts as a receptor for a diverse array of inputs encompassing various facets of the manufacturing process. These inputs include design specifications, material properties, dimensional parameters, and process inputs such as set points and raw material quality. By assimilating this comprehensive dataset, the input module 602 lays the foundation for predictive modeling by providing the necessary contextual information required for accurate forecasting.

The second predictor 600 further includes an output module 604 that serves as a conduit for presenting future estimates related to critical aspects of the manufacturing operation. These estimates encompass a spectrum of variables, including the Remaining Useful Life (RUL) of assets, raw material availability and quality, ambient conditions, and product demand forecasts. Additionally, the output module 604 features a processing time estimate matrix, which provides insights into the anticipated processing times for various combinations of raw materials, product grades, and assets. This matrix enables stakeholders to anticipate production timelines and plan resource allocation, accordingly, thereby enhancing operational efficiency.

LSTM models are particularly well-suited for time-series forecasting tasks, making them ideal for predicting future trends and events based on historical and real-time data. Unlike traditional feedforward neural networks, LSTM models incorporate specialized memory cells and gating mechanisms that allow them to retain and update information over extended time periods, enabling them to learn complex patterns and relationships within sequential data.

In the context of manufacturing, the LSTM model employed by the second predictor 600 leverages historical stored data along with future available data to generate forecasts of critical parameters and variables affecting production processes. These inputs encompass design specifications, process set-points, raw material properties, and historical performance data, providing a comprehensive basis for predictive modelling.

One key application of the LSTM model in the manufacturing plant is in forecasting the remaining useful life (RUL) of assets such as machinery and equipment. By analyzing historical performance data and environmental conditions, the LSTM model can predict the likelihood of equipment failures and deterioration over time, enabling proactive maintenance scheduling and asset management strategies.

In an example the application of the LSTM model involves predicting the RUL of a furnace lining in a steel production facility. By analyzing historical temperature data, process parameters, and maintenance records, the LSTM model can forecast the future degradation of the furnace lining and estimate the remaining operational lifespan.

Additionally, the LSTM model can forecast raw material availability and quality, ambient conditions, and product demand, providing valuable insights for production planning and scheduling. By integrating these forecasts into the scheduling algorithm, manufacturers can optimize resource allocation, minimize downtime, and meet production targets more effectively.

Overall, the second predictor 600 plays a crucial role in anticipating future conditions and events within the manufacturing environment, enabling proactive decision-making and resource management strategies. By leveraging the predictive capabilities of LSTM models, organizations can improve operational efficiency, reduce costs, and enhance overall productivity in dynamic manufacturing settings.

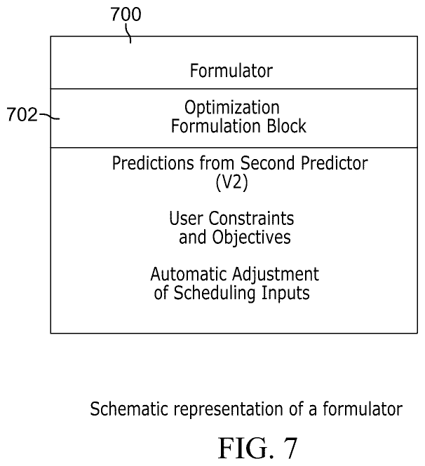

Referring to FIG. 7, illustrates a schematic representation the formulator 700. The formulator serves as a critical component of the job scheduling system, responsible for dynamically adjusting scheduling inputs and parameters based on predictions generated by the first and second predictors. The formulator 700 includes an optimization formulation block 702, which serves as a pivotal component in the system's workflow. This block is tasked with translating the forecasted parameters and user inputs into a precise optimization formulation tailored to the manufacturing environment's specific requirements.

Functioning as an automatic optimization module, the formulator 700 receives inputs from the first predictor and the second predictor, encompassing forecasts of machine conditions, product quality, raw material availability, and other critical variables. Leveraging these predictions, the formulator dynamically modifies the scheduling algorithm to optimize production scheduling decisions over short-term and long-term time intervals.

One key functionality of the formulator is its ability to set constraints and objective values for the scheduling tasks automatically. For instance, if the second predictor forecasts a decrease in raw material availability in the coming days, the formulator may adjust the scheduling algorithm to prioritize jobs requiring less material or reschedule tasks to minimize material waste.

Similarly, if the first predictor detects a potential machinery breakdown in the near future, the formulator may impose constraints on the scheduling algorithm to avoid overloading the affected machine or allocate additional maintenance time to address the issue proactively. By incorporating real-time and forecasted data into the scheduling optimization process, the formulator ensures that production schedules are responsive to changing conditions and aligned with business priorities.

An example scenario illustrating the functionality of the formulator involves a steel manufacturing plant facing fluctuations in raw material availability and ambient conditions. Based on forecasts from the second predictor, the formulator anticipates a shortage of a key raw material and an increase in ambient temperature over the next week.

In response to these predictions, the formulator adjusts the scheduling algorithm to prioritize jobs requiring alternative raw materials or adjust processing parameters to accommodate variations in ambient conditions. Additionally, the formulator may reschedule maintenance activities to coincide with periods of reduced production demand, ensuring optimal utilization of resources and minimizing disruptions to production schedules.

In another example, the formulator 700 analyzes various ambient conditions, including factors such as rainfall, temperature, and humidity, to formulate an optimized workflow in the manufacturing environment, which is located in an area prone to unpredictable weather patterns, including sudden rainfall. As the rain can affect both outdoor operations and indoor conditions through humidity changes, it becomes crucial for the scheduling algorithm to adapt accordingly.

When the formulator module detects an upcoming rainfall event through real-time data from the sensors, it initiates a series of adjustments to the scheduling algorithm. For example, if the rainfall is expected to be heavy, outdoor operations such as material transport or storage may need to be rescheduled or prioritized to avoid delays or damage.

Additionally, the formulator may recommend temporary changes to indoor operations based on the anticipated rise in humidity levels. Certain machining processes, particularly those sensitive to moisture, may require adjustments in parameters or scheduling to maintain product quality and equipment performance. The usage and functioning of the formulator and the scheduler and/or the optimizer as per application attributes. In some cases, the formulator and optimizer may function as a collective module. In some other cases, the formulator only provides solution for an optimization problem, whereas the optimizer may be restricted to providing recommendation actions only.

Furthermore, the formulator considers the forecasted duration and intensity of the rainfall event to optimize resource allocation and minimize disruptions. For instance, if the rain is expected to be short-lived but intense, the scheduling algorithm may prioritize critical tasks or temporarily pause non-essential operations until the weather conditions improve. By leveraging real-time data on ambient conditions and integrating it into the scheduling algorithm, the formulator ensures that the manufacturing environment operates efficiently and effectively even in the face of unpredictable external factors like rainfall. This proactive approach to workflow optimization enhances productivity, minimizes downtime, and preserves product quality despite changing environmental conditions.

Overall, the formulator 700 plays a crucial role in ensuring the efficiency and resilience of production scheduling operations in dynamic manufacturing environments. By integrating predictive insights from the first and second predictors and automatically adjusting scheduling parameters in response to changing conditions, the formulator enables organizations to optimize production schedules, minimize costs, and maintain high levels of operational performance.

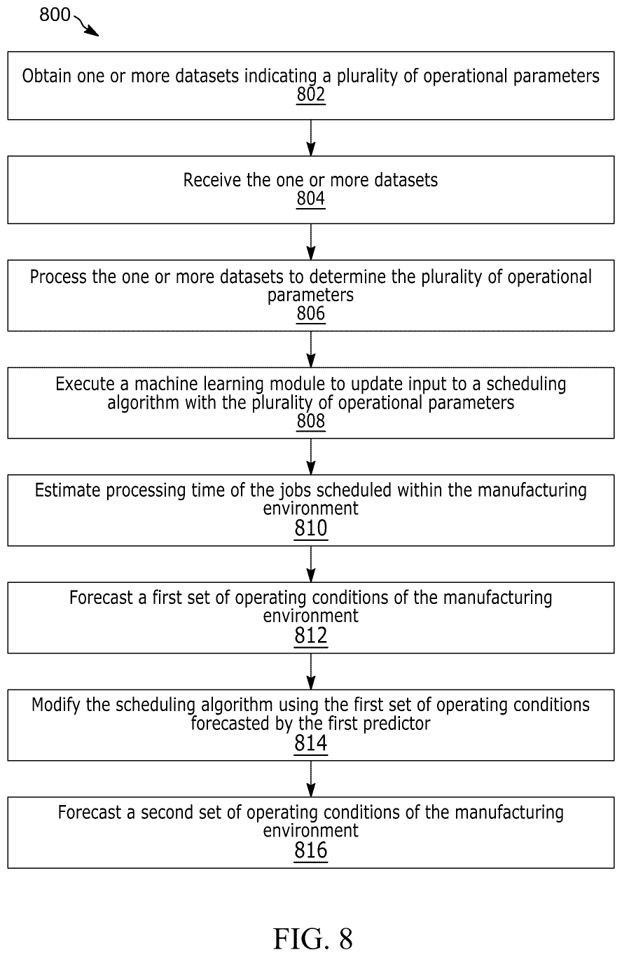

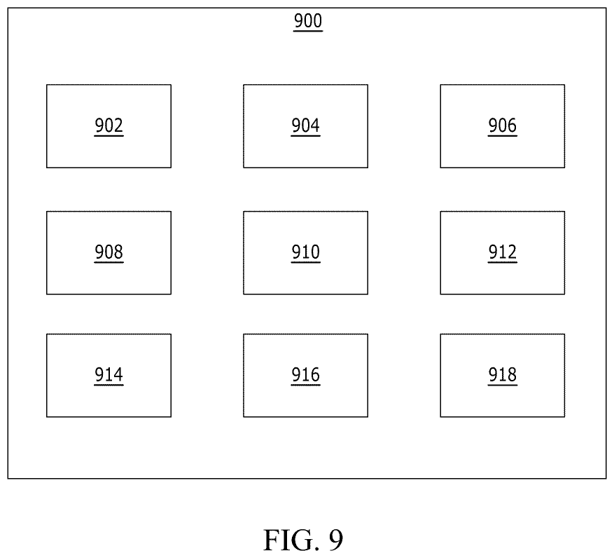

Referring to FIG. 8, illustrates a flowchart for a method 800 for scheduling jobs in the manufacturing environment 100. The method 800 may be performed by the system 120 of the present disclosure. The method 800 may be implemented by a processing resource or a system through any suitable hardware, non-transitory machine-readable medium, or a combination thereof. In some embodiments, steps involved in the method 800 may be executed by a processing resource, for example, the processing unit 120 (shown in FIG. 2) based on instructions stored in a non-transitory computer-readable medium, for example, the memory 904 (shown in FIG. 9). The processing unit 120 may be in communication with additional components. The processing unit 120 may be any device that performs logic operations. The processing unit 120 may include a general processor, a central processing unit, an application specific integrated circuit (ASIC), a digital signal processor, a field programmable gate array (FPGA), a digital circuit, an analog circuit, a controller, a microcontroller, any other type of processor, or any combination thereof. The processing unit 120 may include one or more components operable to execute computer executable instructions or computer code embodied in the memory 904. The method 800 will be described with reference to FIGS. 1-7. The method 800 includes the following steps:

In the first step 802, the method involves obtaining one or more datasets indicating a plurality of operational parameters. These datasets may include sensor data capturing various aspects of machine performance, product quality, raw material availability, and environmental conditions within the manufacturing facility. For example, temperature sensors, pressure sensors, and flow sensors may collect data on process variables such as temperature, pressure, and flow rates during production.

Upon obtaining the datasets, the next step 804 involves receiving the data and preparing it for analysis. This may involve preprocessing steps such as data cleaning, normalization, and aggregation to ensure consistency and accuracy in the dataset. For instance, data from multiple sensors may be integrated and synchronized to provide a comprehensive view of the manufacturing process.

Once the datasets are received, step 806 entails processing the data to determine the plurality of operational parameters. This may involve extracting relevant features and variables from the raw data and transforming it into actionable insights. For example, machine learning algorithms may be used to identify patterns, anomalies, and trends in the data, providing valuable information about machine performance and process stability.

Following data processing, step 808 involves executing a machine learning module to update input to a scheduling algorithm with the operational parameters. The machine learning module utilizes advanced analytics techniques to analyze the processed data and derive insights that inform scheduling decisions. For example, predictive models may be trained to forecast machine downtime, product quality variations, and resource constraints, enabling proactive scheduling adjustments.

Once the scheduling algorithm is updated, step 810 involves estimating the processing time of the jobs scheduled within the manufacturing environment. This estimation takes into account factors such as machine capabilities, process specifications, and raw material availability to predict the time required to complete each job. For instance, historical data on processing times for similar jobs may be used to estimate the duration of upcoming tasks.

Subsequently, step 812 entails forecasting a first set of operating conditions of the manufacturing environment using a first predictor. The first predictor leverages the updated scheduling algorithm and the estimated processing times to forecast future operating conditions such as machine availability, product quality, and resource utilization. For example, based on historical data and current scheduling decisions, the first predictor may anticipate potential bottlenecks or downtime periods within the production process. In another example, the second predictor leverages scheduling algorithm and the estimated processing times to forecast future operating conditions.

After forecasting the first set of operating conditions, step 814 involves modifying the scheduling algorithm based on these predictions. The scheduling algorithm is adjusted to accommodate forecasted changes in machine conditions, product requirements, and resource availability. For instance, if the first predictor forecasts a machine breakdown during a specific time interval, the scheduling algorithm may prioritize alternative tasks or allocate additional resources to mitigate the impact on production schedules.

Finally, step 816 involves forecasting a second set of operating conditions for the specified time intervals using a second predictor. The second predictor utilizes the modified scheduling algorithm and the forecasted first set of operating conditions to predict subsequent conditions within the manufacturing environment. This iterative forecasting process enables the scheduling algorithm to adapt to evolving conditions and optimize production schedules over multiple time intervals.

According to some embodiments, the method further comprises merging the one or more datasets with data of a historical database.

According to some embodiments, the method further comprises updating a machine learning module based on a deviation generated by processing the plurality of operational parameters from the one or more datasets, the first set of operating conditions and the second set of operating conditions.

According to some embodiments, the method further comprises generating an optimized scheduling workflow for each of the first time-interval and the second time interval based on the second set of operating conditions and the modified scheduling algorithm, and wherein the optimized scheduling workflow is generated by setting constraints and objectives for optimization problems.

According to some embodiments, the method further comprises simulating the manufacturing environment based on an optimized scheduling workflow.

According to some embodiments, the method further comprises recommending an optimized scheduling workflow for each of the first time-interval and the second time-interval.

Further in an embodiment, the method may further include performing gathering data from a variety of sensors positioned throughout the manufacturing facility. These sensors capture crucial operational parameters, including machine performance metrics, raw material availability, and environmental conditions.

The method may further include leveraging the latest data, the machine learning module updates its first predictor models. These models, akin to Physics-Informed Neural Networks (PINNs) or Physics-Informed Neural Operators (PINO), adapt to the evolving dynamics of the manufacturing environment. First Set of Parameters Prediction: The refined first predictor models then forecast the initial set of parameters essential for scheduling tasks. These parameters encompass processing times, quality expectations, potential machine faults, and other pertinent factors crucial for efficient scheduling.

The method may further include utilizing the forecasted parameters from the first predictor alongside user inputs such as scheduling horizons (short and long term), the system updates the input to the scheduler. This entails defining/modifying the objective function and constraints, incorporating considerations like machine availability, raw material inventory, and production goals.

The method may further include predicting future operating conditions within the manufacturing environment. This constitutes the generation of the second set of operating parameters, offering insights into potential changes in machine performance, environmental factors, and material availability.

The method may further include leveraging the forecasted data from the second predictor, the system utilizes the first predictor models once again to estimate future processing times for various combinations of machines, raw materials, product grades, and operational sequences.

The method may further include Integrating the second set of operating parameters into the scheduler input, including the refined estimates of future processing times, the system ensures that the scheduling algorithm possesses the most up-to-date information to make informed decisions.

The method may further include executing scheduler and providing recommendations. The scheduler is equipped with the updated input reflecting both current and forecasted conditions, executes its algorithms to generate optimized schedules. These schedules consider dynamic factors and constraints, ultimately providing recommendations for efficient resource utilization and task allocation within the manufacturing environment.

Referring to FIG. 9, illustrates a block diagram of a computer system tailored for scheduling jobs in a manufacturing environment. Central to this system is a non-transitory computer-readable storage medium, denoted as 900, which stores instructions for executing the scheduling process within the manufacturing environment. These instructions, when executed by a processing unit, facilitate the implementation of intelligent scheduling algorithms and decision-making processes to optimize production workflows.

The non-transitory computer-readable storage medium 900 serves as a repository for the software components and algorithms essential for managing job scheduling tasks within the manufacturing environment. These instructions may include algorithms for data processing, machine learning models, optimization algorithms, and scheduling heuristics, among others. The storage medium ensures the persistence and accessibility of these instructions for efficient execution by the processing unit. In addition to the non-transitory computer-readable storage medium, the computer system includes several other modules to support its functionality. These modules include, but are not limited to:

Processing Unit 902: The processing unit executes the instructions stored in the non-transitory computer-readable storage medium, performing computations and decision-making tasks necessary for job scheduling in the manufacturing environment.

Memory 904: The memory module provides temporary storage for data and instructions required during the execution of scheduling algorithms. It may include random-access memory (RAM) or cache memory to facilitate fast access to frequently used data.

Input Device 906: The input device allows users to interact with the computer system, providing input data, commands, and parameters relevant to job scheduling operations. Examples of input devices may include keyboards, mice, touchscreens, or other input interfaces.

Output Device 908: The output device presents the results of scheduling algorithms and analysis to users or other systems. It may include displays, printers, or other output interfaces capable of presenting textual or graphical information.

Network Interface 910: The network interface enables communication between the computer system and external devices or networks. It facilitates data exchange, integration with sensor networks, and connectivity with other manufacturing systems or enterprise software.

Machine Learning Module 912: This module encompasses the machine learning algorithms and models used for predictive analytics and decision-making in job scheduling. It may include components for data preprocessing, feature extraction, model training, and inference.

Scheduler Module 914: The scheduler module orchestrates the scheduling process, determining the optimal allocation of resources, job sequences, and task assignments based on input data and optimization criteria.

Optimization Engine 916: The optimization engine module performs mathematical optimization techniques to optimize scheduling decisions, considering factors such as resource constraints, production objectives, and cost minimization.

User Interface 918: The user interface module provides a graphical or command-line interface for users to interact with the scheduling system. It allows users to input commands, configure scheduling parameters, visualize scheduling results, and receive notifications or alerts.

In summary, the computer system depicted in FIG. 9 comprises various modules and components essential for scheduling jobs in a manufacturing environment. The non-transitory computer-readable storage medium serves as a repository for instructions, algorithms, and data necessary for intelligent scheduling operations, while other modules support computation, data input/output, communication, sensor integration, and user interaction. Together, these components enable efficient and effective job scheduling to optimize manufacturing workflows and enhance productivity.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

What is claimed is:

1. A system for scheduling jobs in a manufacturing environment, the system comprising:
a plurality of sensors configured to obtain one or more datasets indicating a plurality of operational parameters;
a processing unit communicably coupled with the plurality of sensors to:
receive the one or more datasets, and
process the one or more datasets to determine the plurality of operational parameters; and
a machine learning module executed by the processing unit to update a scheduling algorithm with the plurality of operational parameters, the machine learning module comprising:
a first predictor to:
estimate processing time of the jobs scheduled within the manufacturing environment, and
forecast a first set of operating conditions of the manufacturing environment based on the plurality of operational parameters and the processing time;
a formulator to modify the scheduling algorithm using the first set of operating conditions forecasted by the first predictor, wherein the scheduling algorithm is modified for a first time-interval and a second time interval; and
a second predictor to forecast a second set of operating conditions of the manufacturing environment for the first time-interval and the second time interval, wherein the second set of operating conditions are forecast based on the first set of operating conditions and modified scheduling algorithm.

2. The system for scheduling jobs in the manufacturing environment as claimed in claim 1, wherein the operational parameters are selected from a group consisting of:
health and performance of equipment,
quality of input material,
environmental factors, and
quality of output product.

3. The system for scheduling jobs in the manufacturing environment as claimed in claim 1, wherein the processing unit is further configured to merge the one or more datasets with data of a historical database.

4. The system for scheduling jobs in the manufacturing environment as claimed in claim 1, wherein the system further comprises a feedback module to update machine learning module based on a deviation generated by processing the plurality of operational parameters from the one or more datasets, the first set of operating conditions and the second set of operating conditions.

5. The system for scheduling jobs in the manufacturing environment as claimed in claim 1, wherein the first predictor functions on a pre-trained physics-informed neural network models and wherein the second predictor functions on a long short-term memory model.

6. The system for scheduling jobs in the manufacturing environment as claimed in claim 1, wherein the first time-interval is indicative of a short-term period for assigned for executing the scheduling algorithm, and a second time-interval is indicative of a long-term period for executing the scheduling algorithm.

7. The system for scheduling jobs in the manufacturing environment as claimed in claim 1, wherein the formulator is configured to generate an optimized scheduling workflow for each of the first time-interval and the second time interval based on the second set of operating conditions and the modified scheduling algorithm, and wherein the optimized scheduling workflow is generated by setting constraints and objectives for optimization problems.

8. The system for scheduling jobs in the manufacturing environment as claimed in claim 1, wherein the system further comprises a simulator to simulate the manufacturing environment based on an optimized scheduling workflow.

9. The system for scheduling jobs in the manufacturing environment as claimed in claim 1, wherein the system further comprises a recommender to recommend an optimized scheduling workflow for each of the first time-interval and the second time-interval.

10. The system for scheduling jobs in the manufacturing environment as claimed in claim 1, wherein the first set of operating conditions and the second set of operating conditions:
indicate anticipated operational states, processing times and environmental factors of the manufacturing environment; and
are derived from the operational parameters associated with the one or more datasets in real time.

11. A method for scheduling jobs in a manufacturing environment, the method comprising:
obtaining one or more datasets indicating a plurality of operational parameters;
receiving the one or more datasets;
processing the one or more datasets to determine the plurality of operational parameters;
executing a machine learning module to update a scheduling algorithm with the plurality of operational parameters;
estimating processing time of the jobs scheduled within the manufacturing environment;
forecasting, via a first predictor, a first set of operating conditions of the manufacturing environment based on the plurality of operational parameters and the processing time;
modifying the scheduling algorithm using the first set of operating conditions forecasted by the first predictor, wherein the scheduling algorithm is modified for a first time-interval and a second time interval; and
forecasting, via a second predictor, a second set of operating conditions of the manufacturing environment for the first time-interval and the second time interval, wherein the second set of operating conditions are forecast based on the first set of operating conditions and modified scheduling algorithm.

12. The method for scheduling jobs in the manufacturing environment as claimed in claim 11, wherein the operational parameters are selected from a group consisting of:
health and performance of equipment,
quality of input material,
environmental factors, and
quality of output product.

13. The method for scheduling jobs in the manufacturing environment as claimed in claim 11, wherein the method further comprises merging the one or more datasets with data of a historical database.

14. The method for scheduling jobs in the manufacturing environment as claimed in claim 11, wherein the method further comprises updating a machine learning module based on a deviation generated by processing the plurality of operational parameters from the one or more datasets, the first set of operating conditions and the second set of operating conditions.

15. The method for scheduling jobs in the manufacturing environment as claimed in claim 11, wherein the first time-interval is indicative of a short-term period for assigned for executing the scheduling algorithm, and a second time-interval is indicative of a long-term period for executing the scheduling algorithm.

16. The method for scheduling jobs in the manufacturing environment as claimed in claim 11, wherein the method further comprises generating an optimized scheduling workflow for each of the first time-interval and the second time interval based on the second set of operating conditions and the modified scheduling algorithm, and wherein the optimized scheduling workflow is generated by setting constraints and objectives for optimization problems.

17. The method for scheduling jobs in the manufacturing environment as claimed in claim 11, wherein the method further comprises simulating the manufacturing environment based on an optimized scheduling workflow.

18. The method for scheduling jobs in the manufacturing environment as claimed in claim 11, wherein the method further comprises recommending an optimized scheduling workflow for each of the first time-interval and the second time-interval.

19. The method for scheduling jobs in the manufacturing environment as claimed in claim 11, wherein the first set of operating conditions and the second set of operating conditions:
indicate anticipated operational states, processing times and environmental factors of the manufacturing environment; and
are derived from the operational parameters associated with the one or more datasets in real time.

20. A non-transitory computer-readable storage medium storing instructions for scheduling jobs in a manufacturing environment, the instructions when executed by a processing unit causing the processing unit to perform steps including:
obtaining one or more datasets indicating a plurality of operational parameters;
receiving the one or more datasets;
processing the one or more datasets to determine the plurality of operational parameters;
executing a machine learning module to update a scheduling algorithm with the plurality of operational parameters;
estimating processing time of the jobs scheduled within the manufacturing environment;
forecasting, via a first predictor, a first set of operating conditions of the manufacturing environment based on the plurality of operational parameters and the processing time;
modifying the scheduling algorithm using the first set of operating conditions forecasted by the first predictor, wherein the scheduling algorithm is modified for a first time-interval and a second time interval; and
forecasting, via a second predictor, a second set of operating conditions of the manufacturing environment for the first time-interval and the second time interval, wherein the second set of operating conditions are forecast based on the first set of operating conditions and modified scheduling algorithm.
